(19) United States
(12) Patent Application Publication
(10) Pub. No.: US 2014/0298316 A1
(43) Pub. Date: Oct. 2, 2014

(54) Managing method for application program installation and electronic device

(71) Applicant: Wistron Corporation, New Taipei City (TW)

(72) Inventor: Wang Mao, New Taipei City (TW)

(73) Assignee: Wistron Corporation, New Taipei City (TW)

(21) Appl. No.: 14/061,737

(22) Filed: Oct. 23, 2013

(30) Foreign Application Priority Data
Mar. 29, 2013 (CN) 201310109304.7

(51) Int. Cl. G06F 9/445

(52) U.S. Cl. CPC G06F 8/61
USPC 717/174

(57) ABSTRACT

A managing method is utilized for an operating system to manage installation of an application program. The managing method includes storing an installation information in a managing database; and generating a determining result indicating whether the application program is capable of being installed in the operating system according to a program name of the application program and the installation information. The operating system determines whether to install the application program according to the determining result.

### BACKGROUND OF THE INVENTION

1. Field of the Invention

The present invention relates to a managing method and an electronic device, and more particularly, to a managing method and an electronic device capable of easily managing application program installation in an operating system.

2. Description of the Prior Art

With rapid developments of smart phones, tablets, or smart televisions, every device requires a suitable operating system to drive the device operation and to perform basic operations of the device, such as an iOS™ operating system of Apple® or an Android™ operating system of Google®. Among these operating systems, since the Android™ operating system is an open-source operating system and allows developers to understand inner operations of the operating system, the Android™ operating system has become the most popular operating system.

On the other hand, when the device is a device with special functions, an operating system developer of the device may develop an operating system with the special functions, such that the operating performance of the device may be higher and users may more easily use the device. For example, when the device is an e-book reader, the developer of the operating system may develop the operating system with an e-book reading functionality for a special purpose of reading e-books, such as an e-book package operating platform based on the Android™ system. Then, the user does not require operating and using the device in the original operating platform of the Android™ operating system, and the user may more easily read and manage the e-books in the e-book package operating platform. Simultaneously, the executing performance of the e-book reader may also be increased.

In such a condition, if an application program may be installed in the operating system, the user may arbitrarily install the application program in the operating system. When the user installs the application program, which is not allowed by the operating system with the special functions, the application program may be failed and not be operated correctly. Moreover, the application program may affect the operation of the operating system, such as a crash of the operating system or an insufficient resource of the operating system. For example, when the user installs the application program, such as a navigation program or a game, in the e-book reader with the e-book package operating platform, since the application program is not allowed by the e-book package operating platform, the application program may not be operated correctly and may affect the operations of the e-book package operating platform. Then, the application program may also cause the insufficient resource of the e-book reader and the e-book reader is overloaded or crashed.

Thus, the prior art provides to manage installation by a server, that is, the user is required to communicate with the server (such as an application store) through a network. The application program is obtained from the server and installation information indicating whether the application program is capable of being installed in the operating system is also obtained from the server. However, the prior art requires the server to manage and transmit the installation information of the application program. The user requires operating with the server by the network for managing the application program installation, and the managing process is complex and troublesome. Therefore, there is a necessity to provide an easily managing method capable of managing the application program installation in the operating system to avoid the application program, which is not allowed to be installed in the operating system, being installed in the operating system.

### SUMMARY OF THE INVENTION

It is therefore an objective of the present invention to provide a managing method and an electronic device capable of easily managing application program installation in an operating system to avoid an application program, which is not allowed to be installed in the operating system, being installed in the operating system.

The present invention discloses a managing method for an operating system to manage installation of an application program. The managing method comprises storing an installation information in a managing database; and generating a determining result indicating whether the application program is capable of being installed in the operating system according to a program name of the application program and the installation information; wherein the operating system determines whether to install the application program according to the determining result.

The present invention further discloses an electronic device comprising a processor; and a storage device storing an operating system and a program code, wherein the program code is utilized for indicating to the processor to perform a managing method for the operating system to manage installation of an application program, and the managing method comprises storing an installation information in a managing database; and generating a determining result indicating whether the application program is capable of being installed in the operating system according to a program name of the application program and the installation information; wherein the operating system determines whether to install the application program according to the determining result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic device according to an embodiment of the present invention.

FIG. 2 is a flowchart of a managing process according to an embodiment of the present invention.

FIG. 3 is a schematic diagram of another managing process according to an embodiment of the present invention.

### DETAILED DESCRIPTION

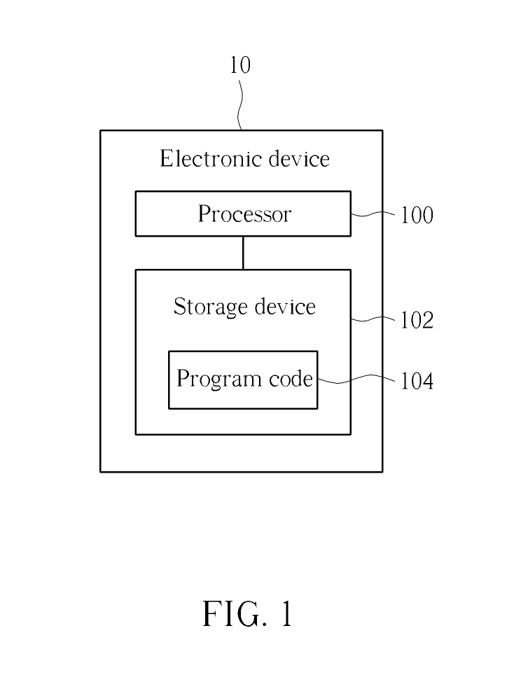

Please refer to FIG. 1, which is a schematic diagram of an electronic device 10 according to an embodiment of the present invention. As shown in FIG. 1, the electronic device 10 includes a processor 100 and a storage device 102. The processor 100 may be a microprocessor or an application-specific integrated circuit (ASIC), and the storage device 102 may be any data storage device. For example, the storage device 102 may be a read-only memory (ROM) , a random-access memory (RAM), a CD-ROM, a magnetic tape, a floppy disk, or an optical data storage device, etc, and is not limited herein. In general, the electronic device 10 may be a smart phone, a tablet, or an e-book reader, etc, and an operating system, such as an Android™ operating system or another system, is stored in the storage device 102 for indicating the processor 100 to perform basic operating processes of the electronic device 10, such as booting and driving the hardware, managing databases or managing files, etc. In addition, the storage device 102 further stores a program code 104 fetched by the processor 100 to perform a managing process of application program installation.

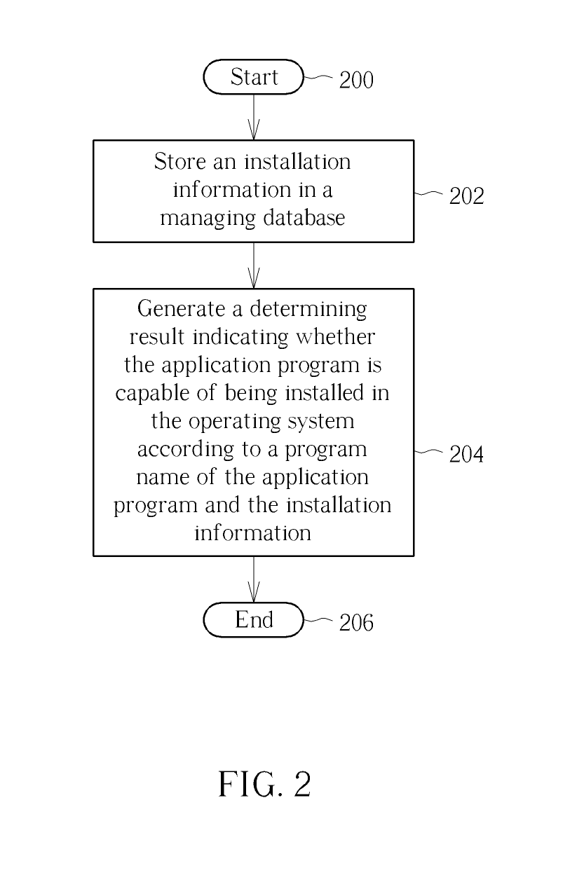

Please refer to FIG. 2, which is a flowchart of a managing process 20 according to an embodiment of the present invention. In the embodiment, the managing process 20 is performed in the electronic device 10 and is compiled as the program code 104 stored in the storage device 102 for indicating to the processor 100 to perform the managing process 20 to manage the application program installation of the operating system in the electronic device 10. As shown in FIG. 2, the managing process 20 includes the following steps:

Step 200: start.

Step 202: store an installation information in a managing database.

Step 204: generate a determining result indicating whether the application program is capable of being installed in the operating system according to a program name of the application program and the installation information.

Step 206: end.

Therefore, the operating system may determine whether to perform the application program installation according to the determining result generated by the managing process 20.

In step 202, a developer of the operating system stores the installation information of the application program installation in the managing database. For example, when the developer develops the operating system with special functions, the developer may store the installation information of the application program, which is allowed to be installed in the operating system with the special functions, in the managing database. The installation information includes information indicating whether the application program to be installed in the operating system and the content of the installation information may be the program name of the application program and a corresponding flag indicating whether the application program is capable of being installed. The required information may also be changed according to an actual requirement and is not limited herein. For example, the installation information maybe a program name list, such as the program name A, the program name B and the program C, for indicating that the program name A, the program name B or the program name C of the application program is capable of being installed. The installation information is stored in a built-in system database of the operating system by a built-in database managing program of the operating system, and the installation information may also be stored in a data file of the operating system by an open file program of the operating system.

In step 204, when the user performs the application program installation in the operating system, first the program name of the application program is obtained by the operating system. Then, the built-in system database of the operating system is read by the built-in database managing program of the operating system and the data file of the operating system is read by the open file program of the operating system to obtain the installation information previously stored by the developer of the operating system. Finally, the installation information is searched to determine whether the program name of the application program exists in the installation information. When the program name exists in the installation program, the determining result is generated and transmitted to the operating system for notifying the operating system to perform the application program installation. When the program name does not exist in the installation program, the determining result is generated and transmitted to the operating system for notifying the operating system not to perform the application program installation.

Therefore, according to the managing process 20, when the user performs the application program installation in the operating system, the present invention may determine whether the program is capable of being installed according to the pre-stored installation information. In other word, by searching the installation information, the application program is easily obtained whether the application program is allowed to be installed. Thereby, the managing process does not require operating with a server by a network to obtain the managing information of the server, and the application program installation may be easily managed.

In addition, the managing process 20 is not limited to be performed in a specific operating system, and may be accordingly altered and implemented according to the system structure of the operating system. For example, in an embodiment, an e-book package operating platform is utilized for managing and reading e-books in the Android™ operating system, and the system developer may have previously stored the program name of the application program, which is allowed to be installed in the e-book package operating platform, in the system database of the Android™ operating system and the system database may be regarded as the e-book package data base. Moreover, the system developer may also have previously established an installation configuration file and similarly the system developer may have stored the program name of the application program, which is allowed to be installed in the e-book package operating platform, in the installation configuration file, and the program name stored in the installation configuration file may be easily modified later by the user to be flexibly changed.

Note that, in the Android™ operating system, the application program is installed in the Android™ operating system by an installation file called as an Android™ package (APK). The user transfers the APK into the Android™ operating system by the network, Bluetooth or universal serial bus (USB) to perform the installation. The program name of the application program may be regarded as the package name of the APK. Thereby, the system developer may previously store the package name, which is allowed to be installed in the e-book package platform, in the e-book package database or the installation configuration file for subsequently managing the application program installation.

Then, when the user performs the installation of the downloaded APK, the package name of the APK may be obtained by the operating system. The e-book package database is read by the database managing program of the Android™ operating system to obtain the installation information previously stored in the e-book package database. The installation information of the e-book package database is searched to determine whether the package name of the APK exists in the installation information of the e-book package database. When the package name of the APK exists in the installation information of the e-book package database, the determining flag is generated and labeled as being installed. Otherwise, when the package name of the APK does not exist in the installation information of the e-book package database, the determining flag is generated and labeled as not being installed. Moreover, the installation configuration file may also be read by the open file program of the Android™ operating system to obtain the installation information previously stored in the installation configuration file. Similarly, the installation information of the installation configuration file is searched to determine whether the package name of the APK exists in the installation information the installation configuration file. When the package name of the APK exists in the installation information the installation configuration file, the determining flag is generated and labeled as being installed. Otherwise, when the package name of the APK does not exist in the installation information the installation configuration file, the determining flag is generated and labeled as not being installed. Finally, the determining flag maybe transmitted to a default installation program of the Android™ operating system, and the installation program determines whether to perform the application program installation according to the determining flag.

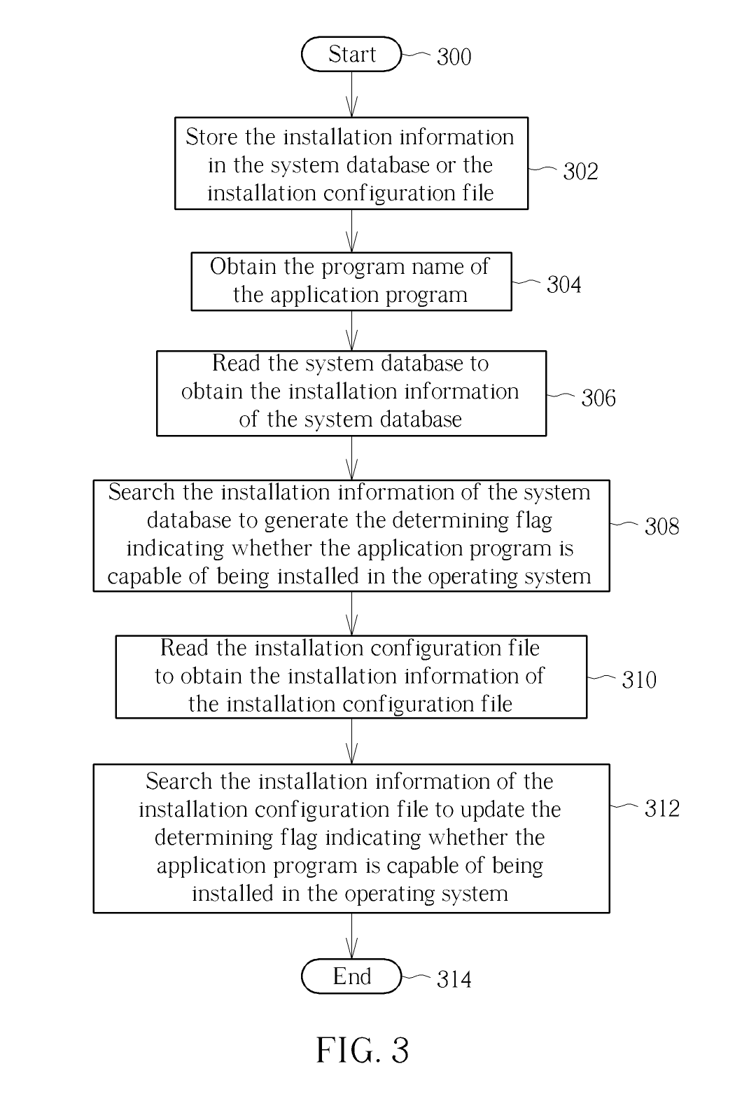

According to the embodiment of the present invention, the management and operation of the application program installation in the Android™ operating system may also be further summarized as a managing process 30, which is performed in the electronic device 10. Please refer to FIG. 3, which is a schematic diagram of the managing process 30 according to an embodiment of the present invention. The managing process 30 may be compiled as the program code 104 stored in the storage device 102 for indicating to the processor 100 to perform the managing process 30. As shown in FIG. 3, the managing process 30 includes the following steps:

Step 300: start.

Step 302: store the installation information in the system database or the installation configuration file.

Step 304: obtain the program name of the application program.

Step 306: read the system database to obtain the installation information of the system database.

Step 308: search the installation information of the system database to generate the determining flag indicating whether the application program is capable of being installed in the operating system.

Step 310: read the installation configuration file to obtain the installation information of the installation configuration file.

Step 312: search the installation information of the installation configuration file to update the determining flag indicating whether the application program is capable of being installed in the operating system.

Step 314: end.

As a result, the operating system may determine whether to perform the application program installation according to the determining flag generated by the managing process 30.

Noticeably, the system structure layer of the Android™ operating system may be divided into an application layer, a framework layer, and a native layer from top to bottom. The main purpose for dividing the system structure layer is that the system developer may decide to apply larger independent application components in the top layer (such as the application layer) or decide to modify smaller program functions in the bottom layer (such as the native layer). Then, developing the system rapidly according to the requirement may be easy to perform for the system developer. Under such a system structured layer, a process of the application program installation is executed first in the top layer of the system structure layer, and then the process is executed in the system core of the bottom layer. Thereby, in order to be applied in the different Android™ operating system developed for the special functions in the different devices, the managing process 30 may preferably be designed to be executed in the native layer of the Android™ operating system and to generate the determining flag for notifying the system core of the Android™ operating system to determine whether to perform the application program installation. In other words, when the managing process 30 is executed in the native layer, the managing process 30 maybe applied in the Android™ operating system, on which is performed different modification by the developer in the application layer or in the framework layer.

In short, the managing process 30 of the present invention is provided for the operating platform, which is specially developed by the system developer. The managing process 30 stores the program name of the application program, which is allowed to be installed in the operating platform, in the operating system to form the installation information. Moreover, in the native layer of the Android™ operating system, the managing process 30 performs reading and searching the installation information to generate the determining flag indicating whether the application program is capable of being installed in the Android™ operating system. Thereby, the managing process 30 may be applied in the operating systems with the different special functions, and the managing process 30 may further easily generate the determining flag to the operating system for determining whether to perform the application program installation. Then, the application program, which is not allowed by the operating platform, maybe prevented from being installed in the operating system with the special functions by the user and affecting the operations of the device.

Specifically, the present invention stores the installation information in the operating system and determines the installation information to manage the application program installation, and those skilled in the art can make modifications or alterations accordingly. For example, in the embodiment, when the program name of the executing application program exists in the installation information, the application program is determined as being installed, and when the program name of the executing application program does not exist in the installation information, the application program is determined as not being installed. However, in another embodiment, the application program may be determined as not being installed when the program name of the executing application program exists in the installation information, and the application program may be determined as being installed when the program name of the executing application program does not exist in the installation information.

Moreover, in the embodiment, the installation information only includes the program name of the application program, which is allowed to be installed. However, in another embodiment, the content of the installation information may also be changed according to the requirement, such as more especially labeling the application program as being installed or not being installed. In such a case, in addition to searching the program name, the label indicating whether the program name is capable of being installed is also required to be searched, which is altered according to the actual condition and is not limited herein.

In summary, when the application program may be installed in the operating system, the user may arbitrarily install the application program in the operating system. Therefore, if the user installs the application program, which is not allowed by the operating system with the special functions, the application program may be failed and not be operated correctly. Moreover, the application program may affect the operation of the operating system. In addition, the prior art requires the server to manage and transmit the installation information of the application program. The user requires operating with the server by the network for managing the application program installation, and the managing process is complex and troublesome. In comparison, the present invention determines whether the application program is allowed to be installed in the operating system by searching the installation information previously stored in the operating system, and the present invention generates the determining result to transmit to the operating system, such that the operating system may determine whether to perform the application program installation. Thereby, the application program installation may be easily managed to be further applied in the operating system with the special functions.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A managing method for an operating system to manage installation of an application program, the managing method comprising:
storing an installation information in a managing database; and
generating a determining result indicating whether the application program is capable of being installed in the operating system according to a program name of the application program and the installation information;
wherein the operating system determines whether to install the application program according to the determining result.

2. The managing method of claim 1, wherein the managing database is a built-in system database managed by the operating system.

3. The managing method of claim 1, wherein the managing database is a data file in the operating system.

4. The managing method of claim 1, wherein the step of generating the determining result indicating whether the application program is capable of being installed in the operating system according to the program name of the application program and the installation information comprises:
obtaining the program name of the application program;
reading the managing database to obtain the installation information; and
searching the installation information to determine whether the program name exists in the installation information and generating the determining result indicating whether the application program is capable of being installed in the operating system.

5. The managing method of claim 4, wherein when the program name exists in the installation information, the determining result is generated to indicate that the application program is capable of being installed in the operating system, and when the program name does not exist in the installation information, the determining result is generated to indicate that the application program is not capable of being installed in the operating system.

6. The managing method of claim 1, wherein the operating system is an Android™ operating system.

7. The managing method of claim 6, wherein the step of determining whether the application program is capable of being installed in the operating system according to the program name of the application program and the installation information is executed in a native layer of the system layer structure of the Android™ operating system.

8. An electronic device comprising:
a processor; and
a storage device storing an operating system and a program code, wherein the program code is utilized for indicating the processor to perform a managing method for the operating system to manage installation of an application program, and the managing method comprises:
storing an installation information in a managing database; and
generating a determining result indicating whether the application program is capable of being installed in the operating system according to a program name of the application program and the installation information;
wherein the operating system determines whether to install the application program according to the determining result.

9. The electronic device of claim 8, wherein the managing database is a built-in system database managed by the operating system.

10. The electronic device of claim 8, wherein the managing database is a data file in the operating system.

11. The electronic device of claim 8, wherein the step of generating the determining result indicating whether the application program is capable of being installed in the operating system according to the program name of the application program and the installation information comprises:
obtaining the program name of the application program;
reading the managing database to obtain the installation information; and
searching the installation information to determine whether the program name exists in the installation information and generating the determining result indicating whether the application program is capable of being installed in the operating system.

12. The electronic device of claim 11, wherein when the program name exists in the installation information, the determining result is generated to indicate that the application program is capable of being installed in the operating system, and when the program name does not exist in the installation information, the determining result is generated to indicate that the application program is not capable of being installed in the operating system.

13. The electronic device of claim 8, wherein the operating system is an Android™ operating system.

14. The electronic device of claim 13, wherein the step of determining whether the application program is capable of being installed in the operating system according to the program name of the application program and the installation information is executed in a native layer of the system layer structure of the Android™ operating system.
